(19) United States
(12) Patent Application Publication
(10) Pub. No.: US 2005/0136208 A1
(43) Pub. Date: Jun. 23, 2005

(54) Transfer-laminating member and production method thereof

(75) Inventors: Tetsu Iwata, Kanagawa (JP); Noboru Kunimine, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/016,721

(22) Filed: Dec. 21, 2004

Related U.S. Application Data
(62) Division of application No. 10/357,226, filed on Feb. 4, 2003.

(30) Foreign Application Priority Data
Feb. 5, 2002 (JP) 2002-028516
Jan. 28, 2003 (JP) 2003-018710

(51) Int. Cl. B32B 9/00; B05D 1/12; B32B 9/04

(52) U.S. Cl. 428/41.8; 427/180; 427/372.2; 427/402; 428/447

(57) ABSTRACT

Disclosed herein is a transfer-laminating member including a heat-resistant base material, a release layer provided in part or in whole on the base material and a surface-protecting layer releasably provided on the release layer and formed by applying and drying a coating formulation with a material for forming the surface-protecting layer dissolved in an organic solvent, wherein the release layer contains particles and is formed by curing a mixture which includes a silicone resin, a melamine resin and an alkyd resin.

### BACKGROUND OF THE INVENTION

1. Field of the Invention

The present invention relates to a transfer-laminating member for forming minute irregularities to a transfer-receiving medium.

2. Related Art

Printed articles by ink-jet, offset printing, gravure printing, electrophotography or the like are known to be improved in fastness properties of images, such as light fastness, water fastness and rub-off resistance, by transfer-laminating a surface-protecting layer on image-formed surfaces (image surfaces) thereof.

As a laminating member, is known a structure that a release layer and a protecting layer have been formed on a base material in that order. In order to improve the visibility of the images, it is known to mat the surface of the surface-protecting layer after transfer.

As methods for matting the surface of the surface-protecting layer, Japanese Patent Application Laid-Open No. 2001-105749 describes methods of causing various kinds of particles to be contained in the release layer and of subjecting a surface of the release layer on the side of the protecting layer to a matting treatment.

When particles are caused to be contained in the release layer, thereby subjecting the surface of the release layer on the side of the protecting layer to matting treatment, a release layer is formed on a base material, and a coating formulation for forming a protecting layer is applied on the release layer to form a laminating member. In this case, the coating formulation is a solution containing a material for forming the surface-protecting layer dissolved in an organic solvent and hardly causes repelling upon coating and also good in drying ability compared with an aqueous solution. However, it is necessary to form the release layer with a solvent-resistant resin.

Resins generally known as solvent-resistant resins include three-dimensionally crosslinking melamine resins and isocyanate-curable urethane resins. However, the melamine resins are required to be crosslinked by drying at a high temperature of at least 140° C., and so there has been an inconvenience of causing deformation even when a heat-resistant base material has been used. Although the isocyanate-curable urethane resins are crosslinked at about 100° C., they are not completely cured by drying under heat upon coating. Thus, it has been necessary that they are aged for about 3 days under an environment of about 60° C. after coating to completely cure them.

### SUMMARY OF THE INVENTION

It is therefore an object of the present invention to provide a laminating member having a release layer curable at a low temperature without need of any aging and having high solvent resistance.

The above object can be achieved by the following respective aspects of the present invention.

In an aspect of the present invention, there is provided a transfer-laminating member comprising a heat-resistant base material, a release layer provided in part or in whole on the base material and a surface-protecting layer releasably provided on the release layer and formed by applying and drying a coating formulation comprising a material for forming the surface-protecting layer dissolved in an organic solvent, wherein the release layer contains particles and is formed by curing a mixture of a silicone resin, a melamine resin and an alkyd resin.

The particles in the release layer may preferably be not softened by drying under heat upon the formation of the release layer and protecting layer,
and, the average particle diameter thereof is preferably from 0.5 μm to 30 μm.

The organic solvent for forming the surface-protecting layer may preferably be any one of methyl ethyl ketone, ethyl acetate and toluene.

In another aspect of the present invention, there is provided a method for producing a transfer-laminating member comprising the steps of:
forming a release layer in part or in whole on a heat-resistant base material by applying onto the base material a coating formulation comprising particles having an average particle diameter of from 0.5 μm to 30 μm and a curable mixture of a thermosetting silicone resin, a melamine resin and an alkyd resin followed by heating and drying to cure the mixture; and
forming a releasable surface-protecting layer on the release layer by applying onto the release layer a coating formulation comprising a material for forming the surface-protecting layer dissolved in an organic solvent followed by heating and drying,
wherein the particles are not softened during the heating and drying.

In the present invention, a transfer-laminating treatment applicable to matting may become feasible at a low process cost by providing a release layer for forming irregularities as a layer composed of a combination of particular resins and having particular properties.

### BRIEF DESCRIPTION OF THE DRAWING

FIG. 1 is a cross-sectional view illustrating an exemplary laminating member according to the present invention.

FIG. 2 typically illustrates an exemplary laminating apparatus to which the laminating member according to the present invention is applied.

### DETAILED DESCRIPTION OF THE PREFERRED EMBODIMENTS

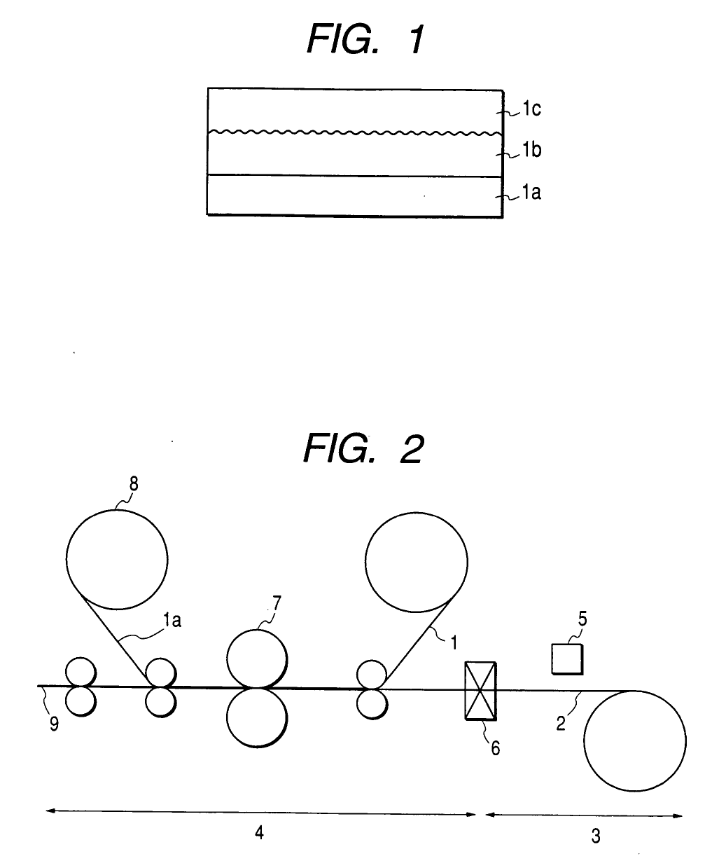

A cross-sectional view of the laminating member according to the present invention is shown in FIG. 1. This laminating member has a structure that a release layer 1b containing particles (hereinafter referred to as “matting material”) for forming irregularities in a surface-protecting layer and a resin, and the surface-protecting layer 1c, which will become a surface-protecting layer for a transfer-receiving layer, such as a printed article obtained by forming an image on a recording medium, when transferred thereto, have been laminated in that order on a heat-resistant base material 1a. The heat-resistant base material may be any material so far as it can stably retain its form under heating and pressurizing when a surface-protecting layer is heated and bonded to an image surface of the printed article under pressure. For example, a film or sheet formed from a material such as polyethylene terephthalate (PET), polyethylene naphthalate (PEN), polyphenylene sulfide (PPS) or polyether sulfone (PES) may be used. It is only necessary for the thickness thereof to be controlled to a thickness suitable for lamination treatment. However, it is preferably within a range of from 4 μm to 50 μm in view of profitability and the difficulty of causing “wrinkles”.

The resin forming the release layer is required to be hard to be dissolved in an organic solvent in a step of coating the release layer comprising a coating formulation with a material for forming the surface-protecting layer dissolved in the organic solvent. When the release layer is easily dissolved in the organic solvent, the irregularity form formed on the surface-protecting layer side of the release layer is deformed, or the matt layer is closely bonded to the surface-protecting layer so that transfer cannot be carried out.

As a resin forming a release layer that can satisfy such conditions, may be mentioned a resin which makes use of a mixture which comprises a silicone resin, a melamine resin and an alkyd resin and is curable by heating.

As for the solvent resistance, it is more preferable that such a resin be hardly soluble in methyl ethyl ketone (MEK), toluene and ethyl acetate, which are generally used as solvents for resins.

The matting material contained in the release layer is composed of particles for forming irregularities and is preferable not to be softened in the heating step when applying the surface-protecting layer and release layer. When the heating temperature is, for example, 80° C., the matting material is preferable not to be softened at 80° C. Since the particles serve to form irregularities in the surface of the release layer to mat the surface of the surface-protecting layer by the irregularities, thereby diffusing light on the surface of the surface-protecting layer after transfer, the average particle diameter thereof is preferably from 0.5 μm to 30 μm. If the average particle diameter is smaller than 0.5 μm, light scattering on the surface of the protecting layer becomes little, and so gloss becomes high. If the average particle diameter exceeds 30 μm, physical bonding between the surface-protecting layer and the particles strengthens, and so the surface-protecting layer becomes hard to be released. It is not preferable to use particle having such a too small or great average particle diameter. Examples of such matting materials include silica gel, acrylic beads, urethane beads and glass beads.

The layer thickness of the release layer may be optional so far as the coating formulation can be easily applied, and can be selected from a range of, for example, from 0.5 μm to 50 μm.

The surface-protecting layer for the transfer-receiving layer serves to form an uppermost layer (surface-protecting layer) laminated on the image surface of the transfer-receiving layer, and no particular limitation is imposed on the material and film thickness thereof so far as such function is satisfied. Therefore, the material may be selected from already known resins according to physical properties required of the surface-protecting layer after transfer. For examples, cellulose acetate butyrate resins, vinyl chloride-vinyl acetate copolymers, polyvinyl butyral resins, acrylic resins and polyester resins may be used. Various kinds of additives may also be contained as needed.

The release layer and surface-protecting layer are formed by repeating the process of preparing a coating formulation obtained by mixing each layer-forming material with a proper solvent as needed, coating the heat-resistant base material with the coating formulation and drying it in order of the release layer and surface-protecting layer, whereby a laminate film can be formed.

An adhesive for making easy to adhere to the surface of the transfer-receiving layer may also be laminated on the surface-protecting layer of the laminate film.

As a coating method of these respective layers, may be used, for example, a roll coating, Wire bar coating, slot die coating or microgravure coating method.

An exemplary apparatus, by which a forming process of a laminated printed article using the laminating member according to the present invention is performed, is illustrated in FIG. 2. The apparatus shown in FIG. 2 has an ink-jet recording section 3 for conducting ink-jet recording on a recording medium 2 wound around a roll and a laminating treatment section 4 for forming a transparent film layer. The ink-jet recording section has an ink-jet recording head 5, by which an ink is applied to an ink-receiving layer of the recording medium 2 according to image information to form an image. After the formation of the image, the recording medium 2 having the image is cut into a proper size by a cutter 6. The laminating member 1 is then passed through between a pair of heated rollers 7 in such a state that the surface-protecting layer 1c is opposed to the ink-receiving layer of the cut recording medium, and pressurized under heat according to the necessity. By this treatment, the surface-protecting layer is bonded under pressure to the ink-receiving layer. Thereafter, the heat-resistant base material 1a and the release layer are pulled up and peeled from the laminate film 1 bonded under pressure to the ink-receiving layer by a winder 8, whereby a laminated printed article that has received the image can be obtained.

The present invention will hereinafter be described more specifically by the following examples. However, the present invention is not limited by these examples at all.

(Formation of Release Layer on Base Material)

### EXAMPLE 1

One hundred parts by mass of SHC 900 (trade name, product of GE Toshiba Silicone Co., Ltd.; a mixed solution of a silicone resin, a melamine resin and an alkyd resin; solvent:metyl ethyl keton; solid content: 30%) were mixed with 3 parts by mass of Sylysia 256 (trade name, product of Fuji Silysia Chemical Co., Ltd.; silica gel; average particle diameter: 3.0 μm), and the resultant mixture was fully stirred to prepare a coating formulation for a release layer. The coating formulation for the release layer was applied on a polyethylene terephthalate film (film thickness: 25 μm) by a Wire bar so as to give a coating weight of 10 g/m² and then dried at 100° C. for 1 minute to obtain a matt film.

### COMPARATIVE EXAMPLE 1

One hundred parts by mass of DST Medium (trade name, product of The Inctec Co.; a mixed solution of a melamine resin, an alkyd resin and silica gel; solvent; mixed solvent of toluene and methyl ethyl ketone; solid content: 30%) were mixed with 4 parts by mass of Cure Top Catalyst (trade name, product of The Intec Co.; IPA solution of an organic acid), and the resultant mixture was fully stirred to prepare a coating formulation for a release layer. The coating formulation for the release layer was applied on a polyethylene terephthalate film (film thickness: 25 μm) by a Wire bar so as to give a coating weight of 10 g/m² and then dried at 100° C. for 1 minute to obtain a matt film.

### COMPARATIVE EXAMPLE 2

Twenty three parts by mass of Desmophen 670BA (trade name, product of Sumitomo Bayer Urethane Co., Ltd.; polyester polyol; solvent; butyl acetate; solid content: 80%) were mixed with 19 parts by mass of Desmodur HLBA (trade name, product of Sumitomo Bayer Urethane Co., Ltd.; isocyanurate; solvent:butyl acetate; solid content: 60%), 3 parts by mass of Sylysia 256 (trade name, product of Fuji Silysia Chemical Co., Ltd.; silica gel; average particle diameter: 3.0 μm) and 57 parts by mass of toluene, and the resultant mixture was fully stirred to prepare a coating formulation for a release layer. The coating formulation for the release layer was applied on a polyethylene terephthalate film (film thickness: 25 μm) by a Wire bar so as to give a coating weight of 10 g/m² and then dried at 100° C. for 1 minute to obtain a matt film.

(Production of Laminating Member)

A coating formulation composed of 100 parts by mass of Dianal BR-82 (trade name, product of Mitsubishi Rayon Co., Ltd.; acrylic resin) as a main material for a surface-protecting layer and 400 parts by mass of an organic solvent was applied on the matt films by a Wire bar and dried at 100° C. for 2 minutes so as to give a dry coating thickness of 5 μm. As the organic solvent, was used methyl ethyl ketone, toluene or ethyl acetate. Vylonal MD-1985 (trade name, product of Toyobo Co., Ltd.; aqueous polyester dispersion) was further applied on the surface-protecting layer by a Wire bar and dried at 100° C. for 2 minutes so as to give a dry coating thickness of 5 μm to obtain a laminate film.

(Production of Laminated Article)

The laminate films (length; 100 mm, width; 100 mm) were placed on an image formed-article (length; 100 mm, width; 100 mm) of LFM-CP420S (trade name, product of Canon Inc.; ink-jet coated paper) as a transfer-receiving layer, and they were passed through between a pair of rollers composed of a steel roller having a diameter of 80 mm heated to 130° C. and a rubber roller having a diameter of 50 mm and nipped under a load of 120 N at a feed rate of 8 mm/sec in such a manner that the laminate film was located on the side of the steel roller, thereby heating and bonding them to each other under pressure to obtain a laminated article.

Evaluation Test: Sellotape (trade name; Sellotape CT-24, product of nitiban Co.) was sticked to the corner of the base material (polyethylene terephthalate film) of the laminated articles obtained in the above-described EXAMPLE and COMPARATIVE EXAMPLES.

And the Sellotape was perpendicularly pulled to peel the surface-protective layer from the release layer. The percentge that the surface-protective layer and the release layer were separated at the surface boundary therebetween was measured. The results are shown in Table 1.

TABLE 1

| Solvent | Ex. 1 | Comp. Ex. 1 | Comp. Ex. 2 |
|---|---|---|---|
| MEK | A | C | C |
| Ethyl | A | C | C |
| acetate | | | |
| Toluene | A | B | C |

Note:
A: 100%
B: 99 to 50%
C: less than 50%

According to the present invention, a transfer-laminating treatment applicable to matting can be performed with ease.

1-2. (canceled)

3. A method for producing a transfer-laminating member comprising a base material, a release layer and a releasable surface-protecting layer arranged in this order, the method comprising the steps of:
forming the release layer by applying onto the base material a coating formulation containing particles and a mixture of a thermally curable silicone resin, a melamine resin and an alkyd resin followed by heating; and
forming the surface-protecting layer by applying onto the release layer a coating formulation comprising a material for forming the surface-protecting layer dissolved in an organic solvent followed by heating and drying.

4. The method for producing a transfer-laminating member according to claim 3, wherein the organic solvent is selected from the group consisting of methyl ethyl ketone, ethyl acetate and toluene.

5. The method for producing a transfer-laminating member according to claim 3, wherein the particles have an average particle diameter of from 0.5 μm to 30 μm.

6. The method for producing a transfer-laminating member according to claim 3, wherein the particles are not softened during the forming steps for the release layer and the surface-protecting layer.

7. The method for producing a transfer-laminating member according to claim 6, wherein the particles are selected from the group consisting of silica gel, acrylic beads, urethane beads and glass beads.
